(19) United States
(12) Patent Application Publication
(10) Pub. No.: US 2001/0016530 A1
(43) Pub. Date: Aug. 23, 2001

(54) Tensioner

(76) Inventors: Rene Grunke, Wittstock (DE); Dieter Schmidt, Nurnberg (DE); Bolko Schuseil, Adelsdorf (DE)

Correspondence Address: HENRY M FEIEREISEN, 350 FIFTH AVENUE, SUITE 3220, NEW YORK, NY, 10118

(21) Appl. No.: 09/777,081

(22) Filed: Feb. 5, 2001

(30) Foreign Application Priority Data
Feb. 4, 2000 (DE) 100 05 073.5

(51) Int. Cl. F16H 7/08; F16H 7/22

(52) U.S. Cl. 474/110; 474/109; 474/101

(57) ABSTRACT

A tensioner, includes a hollow plunger guided in a cylinder for displacement in an axial direction and spring-loaded in a direction of a power transmitting element. A pressure chamber for receiving hydraulic fluid is defined by the cylinder and the plunger. Fitted interiorly of and being immobile with respect to the plunger is a control member which has a closed outer circumference, with a ring-shaped leakage gap formed by the plunger and the control member for passage of hydraulic fluid from the pressure chamber. The control member and the plunger have different coefficient of thermal expansion so that the leakage gap has dimensions which decrease as a temperature of the hydraulic fluid increases.

### CROSS-REFERENCES TO RELATED APPLICATIONS

This application claims the priority of German Patent Application Serial No. 100 05 073.5, filed Feb. 4, 2000, the subject matter of which is incorporated herein by reference.

### BACKGROUND OF THE INVENTION

The present invention relates to a tensioner for a power transmitting element, such as a chain or a belt, for use in internal combustion engines of motor vehicles.

European Pat. No. EP 0 281 990 A1 describes a tensioner having a sleeve and a plunger disposed in and guided longitudinally along the sleeve. The plunger is loaded by a helical spring against a power transmitting element, such as a chain or a belt. To realize a constant sink rate, a separate leakage opening is provided whose cross section can be varied by a control member to form a throttle gap. The control member is suspended within a cage which is formed with breakthroughs for communication with the hydraulic chamber so as to establish a continuous hydraulic connection between the hydraulic chamber and the leakage opening. The amount of hydraulic fluid flowing via the leakage opening is determined by the cross section of the throttle gap. When the hydraulic fluid heats up, the control member expands as a consequence of its higher coefficient of thermal expansion to a greater degree than the plunger and the sleeve, resulting in a narrowing of the throttle gap. Despite decreasing viscosity, a substantially constant amount of hydraulic fluid flows via the leakage opening. The sink rate can therefore be kept constant. The throttle gap is defined by components that are immobile relative to one another, i.e. the control member and the plunger. If a relative movement between the control member and the plunger were to occur, for example as a result of piston movements, there would be a risk that the leakage gap could still be subject to a cross sectional change at same temperature, for example, because the guidance of the control member is not precise. A drawback of this conventional tensioner is also the support of the control member by the cage which itself may be subject to a thermal expansion. Thus, the throttle gap is not only affected by the control member and the plunger but also in an undesired way by the thermal expansion behavior of the cage. As a consequence, uncontrollable changes of the throttle gap may result so that a proper damping function of the tensioner cannot be ensured. It is also disadvantageous, that the pressure in the hydraulic chamber exceeds the pressure in the throttle gap and in the area of the leakage opening. Thus, the cage may deform in view of this uneven pressure application, resulting in an additional reduction of the throttle gap.

It would therefore be desirable and advantageous to provide an improved tensioner, obviating prior art shortcomings and to allow precise adjustment of the leakage gap.

### SUMMARY OF THE INVENTION

The present invention provides for a tensioner a cylinder, a hollow plunger guided in the cylinder for displacement in an axial direction and spring-loaded in a direction of a power transmitting element, a pressure chamber defined by the cylinder and the plunger for receiving hydraulic fluid, a control member fitted interiorly of and being immobile with respect to the plunger and having a closed outer circumference, and a ring-shaped leakage gap formed by the plunger and the control member for passage of hydraulic fluid from the pressure chamber, wherein the control member and the plunger have different coefficient of thermal expansion so that the leakage gap has dimensions which decrease as a temperature of the hydraulic fluid increases.

Through demarcation of the ring-shaped leakage gap by the hollow plunger and the control member with closed outer circumference, the cross section of the leakage gap is determined only by the thermal expansion behavior of the hollow plunger and the control member. Furthermore, the leakage gap is bounded by components that do not move relative to one another so that inadvertent cross sectional fluctuations are no longer encountered as a result of a relative shift of components that define the leakage gap. The adjustment of the cross section of the leakage gap and the temperature-dependent change in cross section of the leakage gap can thus be easily realized.

The materials for the hollow plunger and the control member can now be selected under consideration of their thermal expansion coefficient such that the cross section of the leakage gap is suited to the temperature-dependent viscosity of the hydraulic fluid, typically motor oil. The materials can be so selected that a constant sink rate of the plunger is ensured. There is, however, also the option to so select materials that the sink rate increases or decreases as a function of the temperature. The selection of the materials depends on the requirements at hand.

There are many ways of creating a control member with closed outer circumference so that the peripheral area bounds the leakage gap, only several of which will be detailed here. However, other embodiments which generally follow the concepts outlined here are considered to be covered by this disclosure. A simple option is the configuration of the control member essentially as cylinder, with the circumferential area of the cylinder being closed. The closed circumferential area may, however, have a polygonal or elliptic configuration.

In describing the control member, the term “closed circumferential area” will be used to denote a structure in which the perimeter is continuous and uninterrupted, such as in a circle or ellipse, as opposed, e.g., to a rod which has two ends.

According to another feature of the present invention, the hollow plunger may have a plunger bore which together with the outer circumference of the control member bounds the ring-shaped leakage gap. When configuring the outer circumference of the control member as cylindrical outer peripheral area, the ring-shaped leakage gap resembles a ring with cylindrical outer circumference and cylindrical inner circumference. The ring-shaped leakage gap may, however, also be bounded by a control member having polygonal outer peripheral area. Also in this case, the leakage gap has a ring-shaped configuration.

The control member may be made of plastic, preferably polyamide 66. When using a hollow plunger of steel and a control member of polyamide, and using motor oil as hydraulic fluid, the leakage gap can be easily varied in dependence on the temperature so as to effectuate, for example, a substantially constant sink rate.

A reliable arrangement of the ring-shaped control member in the plunger may be implemented by providing in the plunger an mount in coaxial relationship for support of the control member. The control member can be reliably centered on the mount, whereby a clearance between the mount and the control member is so sized that a thermal expansion of the mount does not influence the thermal expansion behavior of the control member. As a consequence of the coaxial relationship of the mount inside the plunger, a ring-shaped leakage gap is thus evenly formed between the ring-shaped control member and the hollow plunger about its circumference.

According to another feature of the present invention, the mount may be provided with a centering collar for reliably centering the mount in the bore of the plunger. The centering collar may be secured to the hollow plunger through frictional engagement, material engagement or positive engagement. A passage of hydraulic fluid from the pressure chamber into the leakage gap may be implemented by providing the centering collar with several circumferentially spaced indentations.

According to another feature of the present invention, there may be provided an opening between the plunger bottom and the mount for passage of hydraulic fluid.

According to another feature of the present invention, there may be provided a support member between the mount and the plunger bottom for support of the mount, wherein the support member is provided with recesses for passage of hydraulic fluid.

The control member may be made of a material which has a thermal expansion coefficient which exceeds the thermal expansion coefficient of the material of the plunger. As the plunger is guided in the cylinder for longitudinal displacement and as the thermal expansion of the plunger should be as small as possible at temperature changes in order to realize a consistently good guidance, it may be suitable to select the material for fabricating the control member with a great thermal expansion coefficient. An example of a suitable material includes polyamide 66 which can easily be handled in the injection process.

According to another feature of the present invention, the control member may be made of a disk-shaped configuration and disposed between the bottom of the hollow plunger and a support disk. In this way, the control member is secured in axial directions with respect to the hollow plunger, whereby an axial clearance may be provided to permit thermal expansion of the control body in axial directions. The support disk may at the same time serve as abutment for a helical compression spring which acts upon the cylinder, on the one hand, and on the plunger, on the other hand.

According to another feature of the present invention, the control member may form together with the hollow plunger an inlet and an outlet. For this purpose, the substantially cylindrical control member may be provided with truncated cone shaped surfaces for defining the inlet and the outlet. Even when the control member bears with its end faces upon neighboring components, the inlet and outlet have substantially triangular ring-shaped cross section, so that the hydraulic fluid may flow unhindered into and out of the leakage gap.

### BRIEF DESCRIPTION OF THE DRAWING

Other features and advantages of the present invention will be more readily apparent upon reading the following description of a preferred exemplified embodiment of the invention with reference to the accompanying drawing, in which:

FIG. 1 is a longitudinal section of one embodiment of a tensioner according to the present invention;

FIG. 2 is a top view, depicting in detail a support member for use in the tensioner of FIG. 1;

FIG. 3 is a top view, depicting in detail an mount for use in the tensioner of FIG. 1;

FIG. 4 is a longitudinal section of another embodiment of a tensioner according to the present invention; and

FIG. 5 is a longitudinal section of still another embodiment of a tensioner according to the present invention.

### DETAILED DESCRIPTION OF PREFERRED EMBODIMENTS

Throughout all the Figures, same or corresponding elements are generally indicated by same reference numerals.

Turning now to the drawing, and in particular to FIG. 1, there is shown a longitudinal of one embodiment of a tensioner according to the present invention, including a cylinder 1 and a hollow plunger 2 defining a bore 9 and guided in the cylinder 1 for displacement in a longitudinal direction. The cylinder 1 is open at one end to allow displacement of the plunger 2, as shown on the left half of the tensioner in FIG. 1, and closed by a cover 22 at the other end. A helical compression spring 3 is supported by the cylinder 1 and biases the plunger 2 in a direction of a power transmitting member (not shown), such as a chain or a belt. The plunger 2 and the cylinder 2 bound together a pressure chamber 4 for hydraulic fluid, e.g. motor oil.

The cover 22 has a passageway 23 which is fluidly connected to the pressure chamber 4, whereby the flow of hydraulic fluid through the passageway 23 is controlled by a check valve 5 that opens only for flow of hydraulic fluid into the hydraulic chamber 4, and closes the passage in the reverse situation.

Disposed in the hollow plunger 2 is a mount 6 which is centered in the plunger 2 via a centering collar 7. A control member 8 in the form of a ring, and thus of closed circumferential area, is positioned on a radial shoulder 24 of the mount 6 and made of plastic, e.g. polyamide 66. The ring-shaped control member 8 is formed integrally with a bracket 8a and disposed in centered relationship on the mount 6. Formed between the cylindrical outer peripheral surface of the control member 8 and the bore 9 of the plunger 2 is a ring-shaped leakage gap 10. Thus, when the plunger 2 is moved to protrude further out of the cylinder 1, as shown on the left side, hydraulic fluid is aspirated to flow through the passageway 23 into the pressure chamber 4 via the check valve 5, and when the plunger 2 is urged into the cylinder 1, as shown on the right side, hydraulic fluid is pressurized, thereby increasing the pressure in the pressure chamber 4. The hydraulic fluid in the pressure chamber 4 thus gradually leaks through the leakage gap 10, thereby damping the movement or speed of the plunger 2.

A possibly existing gap between the mount 6 and the control member 8 may, for example, be sealed by the provision of sealing rings (not shown) upon the end faces of the control member 8.

The control member 8 has axial ends in the form of truncated cone shaped surfaces 10a, 10b which, together with the plunger 2, define an inlet 10c an outlet 10d, respectively. The inlet 10c and the outlet 10d are provided to allow hydraulic fluid to flow unobstructed in front of and behind the leakage gap 10.

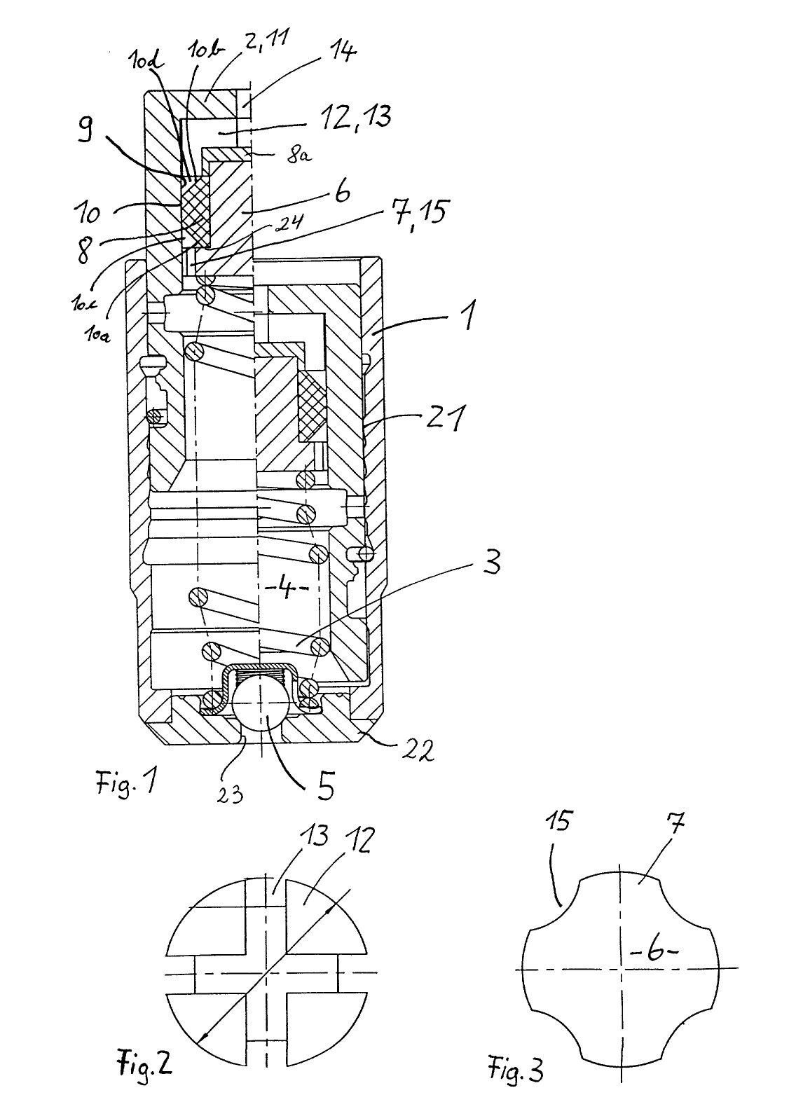

Arranged between the mount 6 and the bottom 11 of the plunger 2 is a support member 12 which is shown in more detail in FIG. 2 by way of a top view. The support member 12 is formed with recesses 13 so that hydraulic fluid exiting the leakage gap 10 can flow through the recesses 13 and ultimately escape through an opening 14 in the bottom 11 of the plunger 2.

The helical compression spring 3 presses against the mount 6 which bears in axial direction against the support member 12 positioned at the bottom 11 of the plunger 2.

The mount 6 is shown in more detail in FIG. 3 by way of a top view, and it can be seen that the centering collar 7 is formed about its circumference with several spaced-apart indentations 15 for passage of hydraulic fluid.

Referring now to FIG. 4, there is shown a longitudinal section of another embodiment of a tensioner according to the present invention. Parts corresponding with those in FIG. 1 are denoted by identical reference numerals and not explained again. In this embodiment, the mount 6 is supported directly upon the bottom 11 of the plunger 2 and has bores 16 for passage of hydraulic fluid. Thus, hydraulic fluid migrating from the leakage gap 10 can escape through the bores 16 and ultimately through the opening 14.

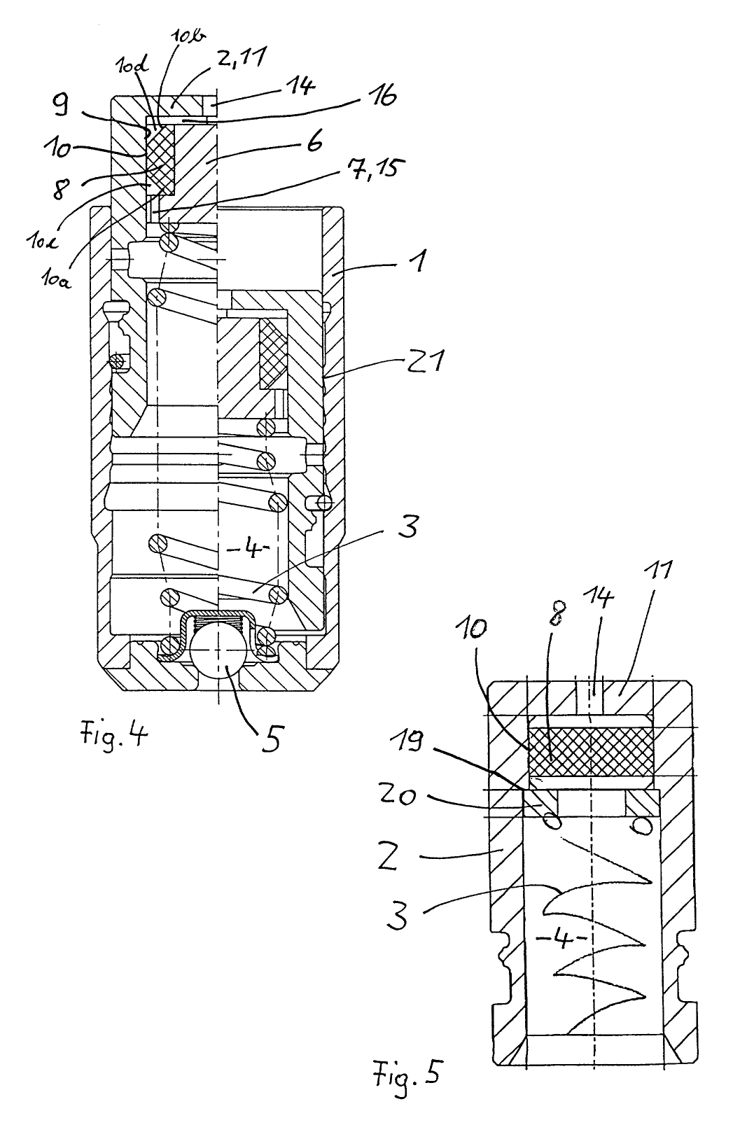

FIG. 5 illustrates still another embodiment of a tensioner according to the present invention. For sake of simplicity, the depiction of the cylinder 1 has been omitted. In this embodiment, provision is made for a control member 8 in the form of a disk for disposition in the bore 9 such that the disk-shaped control member 8 bears in one axial direction upon the plunger bottom 11 and in the other axial direction upon the support disk 20. Formed between the plunger bore 9 and the circular outer circumference of the disk-shaped control member 8 is the leakage gap 10. The plunger 2 is formed with a shoulder 19 for axial support of a support disk 20, whereby the helical compression spring 3 biases the support disk 20 against the shoulder 19. The disk-shaped control member 8 is held immobile with respect to the plunger 2 in axial directions apart from a possible axial play for compensation of thermal expansions.

The operation of the tensioner according to the present invention is as follows: As the plunger 2 is urged into the cylinder 1, as shown on the right side, hydraulic fluid is pressurized, thereby increasing the pressure in the pressure chamber 4. The hydraulic fluid in the pressure chamber 4 thus gradually leaks through the leakage gap 10, thereby damping the movement or speed of the plunger 2. The leakage gap 10 acts hereby as throttle. When the hydraulic fluid is cold, a correlation is established between the diameter of the plunger bore 9 and the diameter of the control member 8, which correlation is determinative for the cross section of the leakage gap 10. This cross section relates to the viscosity of the cold hydraulic fluid. As the temperature of the hydraulic fluid rises during operation of the internal combustion engine, also the plunger 2 and the control member 8 heat up. The thermal expansion of the control member 8 is hereby greater than the thermal expansion of the plunger 2. As a consequence, the relationship of the diameter of the plunger bore 9 to the diameter of the control member 8 changes in a way that the cross section of the leakage gap 10 decreases so that the cross section of the leakage gap 10 is again suited to the changed viscosity of the heated hydraulic fluid.

In accordance with the invention, the cross section of the leakage gap 10 is now solely determined by the control member 8 and the hollow plunger 2. As the leakage gap 10 can be dimensioned by considering only the thermal expansion behavior of two components, which are immobile relative to one another, the cross section of the leakage gap 10 can be reliably matched to the respective viscosity of the hydraulic fluid.

As is further shown in FIGS. 1, 4 and 5, an additional leakage gap 21 is provided between the hollow plunger 2 and the cylinder 1. The leakage gap 21 in combination with the leakage gap 10, which adjusts in dependence on the temperature, effects a damping action in which the leakage gap 21 assumes the base damping effect which is superimposed by the variable damping action realized via the leakage gap 10.

While the invention has been illustrated and described as embodied in a tensioner, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A tensioner, comprising:
a cylinder defining an axis;
a hollow plunger guided in the cylinder for displacement in an axial direction and spring-loaded in a direction of a traction member;
a pressure chamber defined by the cylinder and the plunger for receiving hydraulic fluid;
a control member fitted interiorly of and being immobile with respect to the plunger and having a closed outer circumference; and
a ring-shaped leakage gap formed by the plunger and the control member for passage of hydraulic fluid from the pressure chamber, said control member and said plunger having different coefficient of thermal expansion so that the leakage gap has dimensions which decrease as a temperature of the hydraulic fluid increases.

2. The tensioner of claim 1, and further comprising a mount arranged interiorly of the plunger in coaxial relationship, said control member being a ring placed upon the mount.

3. The tensioner of claim 2, wherein the plunger defines a bore, said mount having a collar to center the mount in the bore of the plunger.

4. The tensioner of claim 3, wherein the collar has several circumferentially spaced indentations for passage of hydraulic fluid.

5. The tensioner of claim 2, wherein the plunger has a bottom, said bottom and said mount defining an opening for passage of hydraulic fluid.

6. The tensioner of claim 5, and further comprising a support member disposed between the mount and the bottom for support of the mount, said support member having recesses for passage of hydraulic fluid.

7. The tensioner of claim 1, wherein the plunger is made of a material and the control member is made of a material, wherein the coefficient of thermal expansion of the material of the control member is greater than the coefficient of thermal expansion of the material of the plunger.

8. The tensioner of claim 1, wherein the control member is made of plastic.

9. The tensioner of claim 8, wherein the control member is made of polyamide 66.

10. The tensioner of claim 1, wherein the plunger has a bottom, said control member being disposed between the bottom and the support member.

11. The tensioner of claim 1, wherein the control member has a disk-shaped configuration.

12. The tensioner of claim 1, wherein the control member and the plunger commonly define an inlet and an outlet for hydraulic fluid.

13. The tensioner of claim 12, wherein the control member has a substantially cylindrical configuration and is formed with truncated cone shaped surfaces for demarcating the inlet and the outlet.

14. A tensioner, comprising:
a cylinder defining an axis;
a plunger moveable in an axial direction in the cylinder for tensioning a power transmitting element;
a control member received interiorly of the plunger; and
a pressure chamber defined by the cylinder and the plunger for receiving hydraulic fluid;
wherein the control member and the plunger have confronting surfaces configured to define a ring-shaped leakage gap therebetween about the axis for passage of hydraulic fluid from the pressure chamber, said control member and said plunger having different thermal expansion coefficients and structured as a self-contained system so that the leakage gap responds in size automatically to a temperature change of the hydraulic fluid.

15. The tensioner of claim 14, wherein the control member has a ring-shaped configuration.

16. The tensioner of claim 15, and further comprising a mount centered in the plunger for support of the control member.

17. The tensioner of claim 16, wherein the mount has a passageway for hydraulic fluid.

18. The tensioner of claim 14, wherein the plunger is made of a material and the control member is made of a material, wherein the coefficient of thermal expansion of the material of the control member is greater than the coefficient of thermal expansion of the material of the plunger.

19. The tensioner of claim 14, wherein the control member is made of plastic.

20. The tensioner of claim 19, wherein the control member is made of polyamide 66.

21. The tensioner of claim 14, wherein the control member has a disk-shaped configuration.

22. The tensioner of claim 14, wherein the control member has a substantially cylindrical configuration and is formed with truncated cone shaped surfaces to define spaces representing passages for hydraulic fluid.
